(19) United States
(12) Patent Application Publication
(10) Pub. No.: US 2024/0057081 A1
(43) Pub. Date: Feb. 15, 2024

(54) DEFAULT BEAM RULE FOR UNIFIED TRANSMISSION CONFIGURATION INDICATION (TCI) IN MULTIPLE DOWNLINK CONTROL INFORMATION MESSAGE (mDCI), MULTIPLE TRANSMIT AND RECEIVE POINT (mTRP) SCENARIO

(71) Applicant: QUALCOMM Incorporated, San Diego, CA (US)

(72) Inventors: Tianyang BAI, Somerville, NJ (US); Yan ZHOU, San Diego, CA (US); Tao LUO, San Diego, CA (US); Junyi LI, Fairless Hills, PA (US)

(21) Appl. No.: 18/352,203

(22) Filed: Jul. 13, 2023

Related U.S. Application Data
(60) Provisional application No. 63/397,760, filed on Aug. 12, 2022.

(51) Int. Cl. H04W 72/1273; H04W 72/232; H04B 7/06

(52) U.S. Cl. CPC H04W 72/1273; H04W 72/232; H04B 7/0695

(57) ABSTRACT

A method receives a configuration for enabling a per transmit and receive point (TRP) default beam mode. The method receives a first scheduling downlink control information message (DCI) from a first TRP and a second scheduling DCI from a second TRP. The first DCI schedules a first downlink transmission for the UE at a first time after receiving the first DCI. A first duration between the first time and a second time when receiving the first DCI is less than a threshold. The second DCI schedules a second downlink transmission for the UE at a third time after receiving the second DCI. A second duration between the third time and a fourth time when receiving the second DCI is less than the threshold. The method communicates with the first TRP with a first default beam, and with the second TRP with a second default beam.

### CROSS-REFERENCE TO RELATED APPLICATION

The present application claims the benefit of U.S. Provisional Patent Application No. 63/397,760, filed on Aug. 12, 2022, and titled “DEFAULT BEAM RULE FOR UNIFIED TRANSMISSION CONFIGURATION INDICATION (TCI) IN MULTIPLE DOWNLINK CONTROL INFORMATION (mDCI) MULTIPLE TRANSMIT AND RECEIVE POINT (mTRP) SCENARIO,” the disclosure of which is expressly incorporated by reference in its entirety.

### FIELD OF THE DISCLOSURE

The present disclosure relates generally to wireless communications, and more specifically to a default beam rule for a unified transmission configuration indication (TCI) in multiple downlink control information message (mDCI), multiple transmit and receive point (mTRP) scenarios.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for wireless communication, by a user equipment (UE) includes receiving a configuration for enabling a per transmit and receive point (TRP) default beam mode. The method also includes receiving a first scheduling downlink control information message (DCI) from a first TRP. The first scheduling DCI schedules a first downlink transmission for the UE at a first time after receiving the first scheduling DCI. A first duration between the first time and a second time when receiving the first scheduling DCI is less than a threshold time interval. The method further includes receiving a second scheduling DCI from a second TRP. The second scheduling DCI schedules a second downlink transmission for the UE at a third time after receiving the second scheduling DCI. A second duration between the third time and a fourth time when receiving the second scheduling DCI is less than the threshold time interval. The method also includes communicating with the first TRP with a first default beam for the first downlink transmission, and communicating with the second TRP with a second default beam.

In other aspects of the present disclosure, a method of wireless communication, by a network device includes transmitting a configuration for enabling a per transmit and receive point (TRP) default beam mode. The method also includes transmitting a first scheduling downlink control information message (DCI), the first scheduling DCI scheduling a first downlink transmission for a user equipment (UE) at a first time after receiving the first scheduling DCI. A first duration between the first time and a second time when receiving the first scheduling DCI is less than a threshold time interval. The method further includes communicating with the UE with a first default beam of the UE for the first downlink transmission.

Other aspects of the present disclosure are directed to an apparatus. The apparatus has a memory and one or more processors coupled to the memory. The processor(s) is configured to receive a configuration for enabling a per transmit and receive point (TRP) default beam mode. The processor(s) is also configured to receive a first scheduling downlink control information message (DCI) from a first TRP. The first scheduling DCI schedules a first downlink transmission for the UE at a first time after receiving the first scheduling DCI. A first duration between the first time and a second time when receiving the first scheduling DCI is less than a threshold time interval. The processor(s) is further configured to receive a second scheduling DCI from a second TRP. The second scheduling DCI schedules a second downlink transmission for the UE at a third time after receiving the second scheduling DCI. A second duration between the third time and a fourth time when receiving the second scheduling DCI is less than the threshold time interval. The processor(s) is also configured to communicate with the first TRP with a first default beam for the first downlink transmission, and to communicate with the second TRP with a second default beam.

Other aspects of the present disclosure are directed to an apparatus. The apparatus has a memory and one or more processors coupled to the memory. The processor(s) is configured to transmit a configuration for enabling a per transmit and receive point (TRP) default beam mode. The processor(s) is also configured to transmit a first scheduling downlink control information message (DCI). The first scheduling DCI schedules a first downlink transmission for a user equipment (UE) at a first time after receiving the first scheduling DCI. A first duration between the first time and a second time when receiving the first scheduling DCI is less than a threshold time interval. The processor(s) is further configured to communicate with the UE with a first default beam of the UE for the first downlink transmission.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a block diagram illustrating a beam indication downlink control information message (DCI) without a downlink assignment, in accordance with various aspects of the present disclosure.

FIG. 5 is a flow diagram illustrating an example process performed, for example, by a user equipment (UE), in accordance with various aspects of the present disclosure.

FIG. 6 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

A unified transmission configuration indicator (TCI) exists for single transmit and receive point (TRP) deployments. It may be desirable to extend the unified TCI to multiple transmit and receive point (mTRP) cases. A unified TCI framework indicates multiple downlink (DL) and/or uplink (UL) transmission configuration indicator states.

In the case when multiple downlink control information messages (mDCIs) are used for mTRP deployments, each TRP is associated with a dedicated resource pool, referred to as a control resource set (CORESET) pool. Each TRP transmits its own physical downlink control channel (PDCCH) from the associated CORESET to schedule communications from the same TRP. In other words, the DCI from a TRP will schedule the communication from the same TRP. TCI states are associated with each CORESET pool of the TRP.

A current default beam rule for a single TRP with unified TCI is as follows: when a time offset between a scheduling DCI and scheduled aperiodic channel state information reference signal (AP-CSI-RS)/physical downlink shared channel (PDSCH) is smaller than a predefined threshold, a default beam will be used. That is, when the time is too short for the UE to prepare a beam, a default beam is selected.

How a component carrier (CC) is configured dictates how the default beam is selected. A first rule applies when the component carrier is not configured with inter-cell beam management. The first rule defines the default beam as the beam with the indicated TCI that is active in the slot of the scheduled AP-CSI-RS/PDSCH. A second rule applies when the component carrier is configured with inter-cell beam management. The second rule defines the default beam as the beam with a lowest CORESET beam identifier (ID) in a latest CORESET monitoring occasion before the slot of the scheduled AP-CSI-RS/PDSCH.

According to aspects of the present disclosure, a network device, such as a base station, may configure whether a per TRP default beam mode is enabled. If the default beam mode is enabled, each TRP/CORESET pool will have its own default beam if the time is too short for the user equipment (UE) to prepare a beam for the scheduled transmission. The default beam may be based on which CORESET pool is associated with the scheduling DCI. In this case, the corresponding default beam will be used. For example, when a component carrier is not associated with inter-cell beam management, then the default beam for a given CORESET pool index is the indicated downlink applicable TCI state for that CORESET pool index in the slot of the scheduled PDSCH/AP-CSI-RS. According to aspects of the present disclosure, the default beam for TRPs with inter-cell beam management will be the TCI of the lowest CORESET ID in the latest CORSET monitoring occasion of the corresponding CORESET pool for the DCI of the TRP that occurs before the scheduled slot of the PDSCH/AP-CSI-RS.

According to aspects of the present disclosure, if the per TRP default beam mode is not enabled, then the same default beam will be applied to PDSCH and AP-CSI-RS across all TRPs. According to further aspects of the present disclosure, a UE may transmit a UE capability message regarding the per TRP default beam mode. If supported, the network device may configure the per TRP default beam mode for the UE.

According to aspects of the present disclosure, if a UE is enabled with a default beam rule for mDCI, mTRP scenarios, then the default beam for a given CORESET pool index is the indicated downlink applicable TCI state for that CORESET pool index. If the UE is not configured with the default beam rule and both indicated downlink applicable TCI states are not associated with any additional physical cell ID for a neighbor cell, the single default beam for both CORESET pool indexes is the indicated downlink applicable TCI state for a predefined CORESET pool index. If the UE is not configured with the default beam rule and at least one of the indicated downlink applicable TCI states is associated with an additional physical cell ID for a neighbor cell, then the single default beam follows the receive beam for the CORESET with a lowest ID in the latest monitored slot.

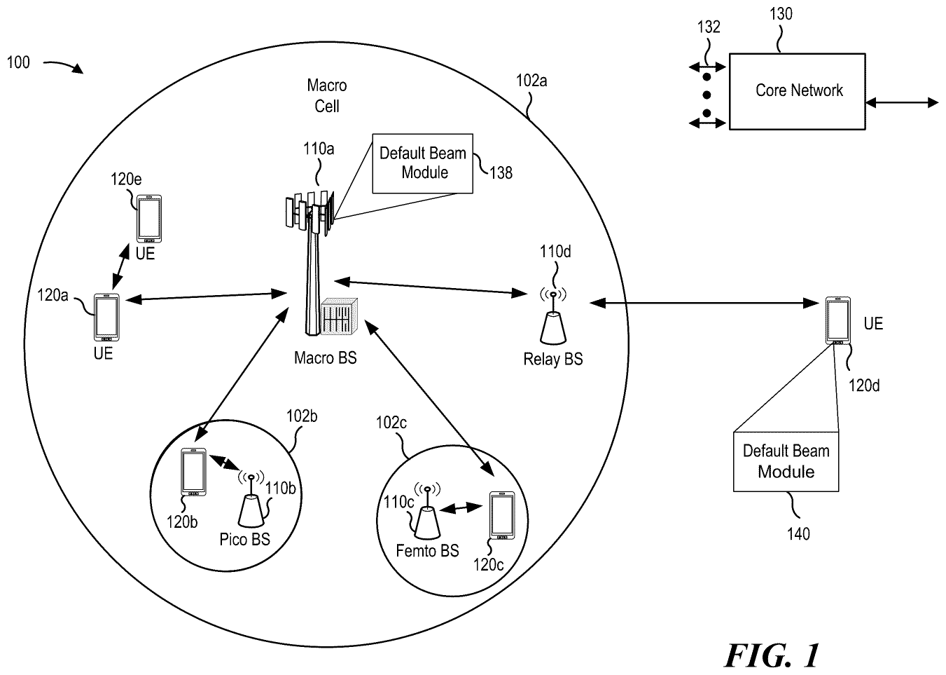

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a default beam module 140. For brevity, only one UE 120d is shown as including the default beam module 140. The default beam module 140 may receive a configuration for enabling a per transmit and receive point (TRP) default beam mode. The default beam module 140 may also receive a first scheduling downlink control information message (DCI) from a first TRP. The first scheduling DCI schedules a first downlink transmission for the UE at a first time after receiving the first scheduling DCI, a first duration between the first time and a second time when receiving the first scheduling DCI being less than a threshold time interval. The default beam module 140 may further receive a second scheduling DCI from a second TRP. The second scheduling DCI schedules a second downlink transmission for the UE at a third time after receiving the second scheduling DCI, a second duration between the third time and a fourth time when receiving the second scheduling DCI being less than the threshold time interval. The default beam module 140 may also communicate with the first TRP with a first default beam for the first downlink transmission, and communicate with the second TRP with a second default beam.

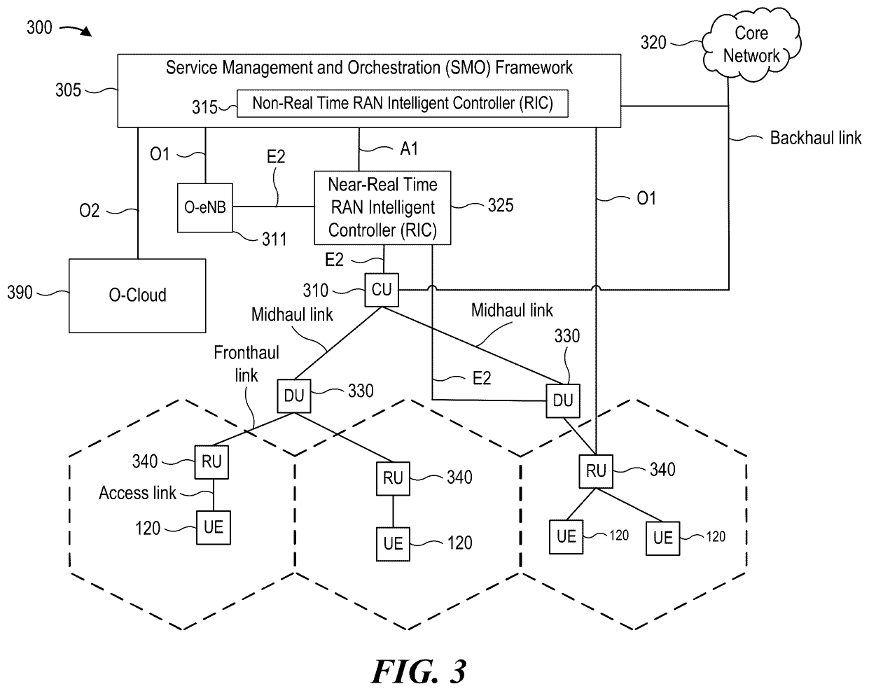

The core network 130 or the base stations 110 or any other network device (e.g., as seen in FIG. 3) may include a default beam module 138. For brevity, only one base stations 110a is shown as including the default beam module 138. The default beam module 138 may transmit a configuration for enabling a per transmit and receive point (TRP) default beam mode. The default beam module 138 may also transmit a first scheduling downlink control information message (DCI). The first scheduling DCI schedules a first downlink transmission for a user equipment (UE) at a first time after receiving the first scheduling DCI, a first duration between the first time and a second time when receiving the first scheduling DCI being less than a threshold time interval. The default beam module 138 may further communicate with the UE with a first default beam of the UE for the first downlink transmission.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information message (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

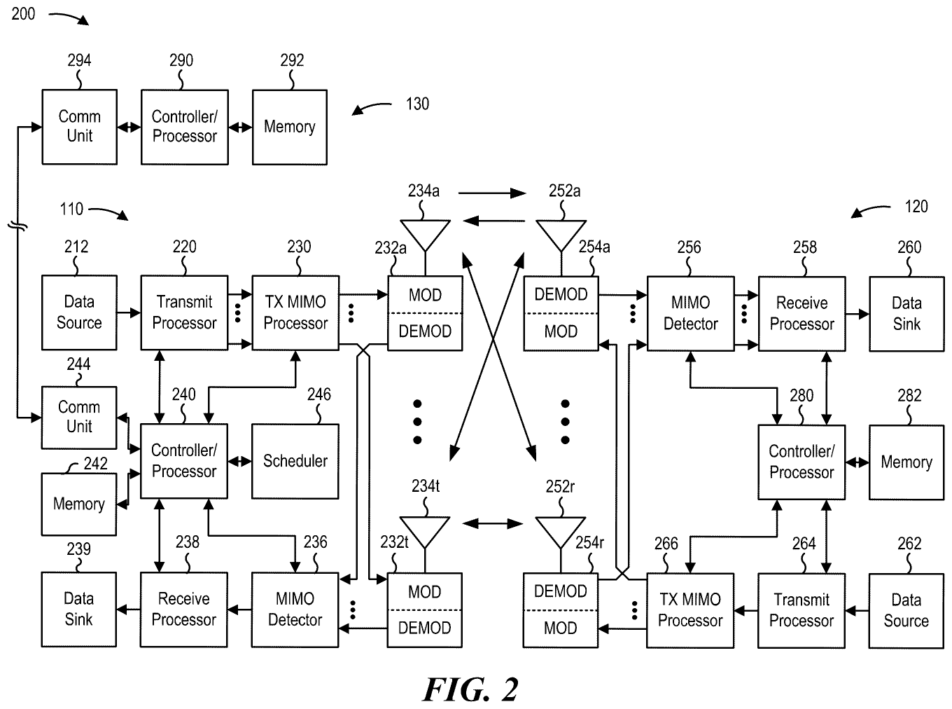

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

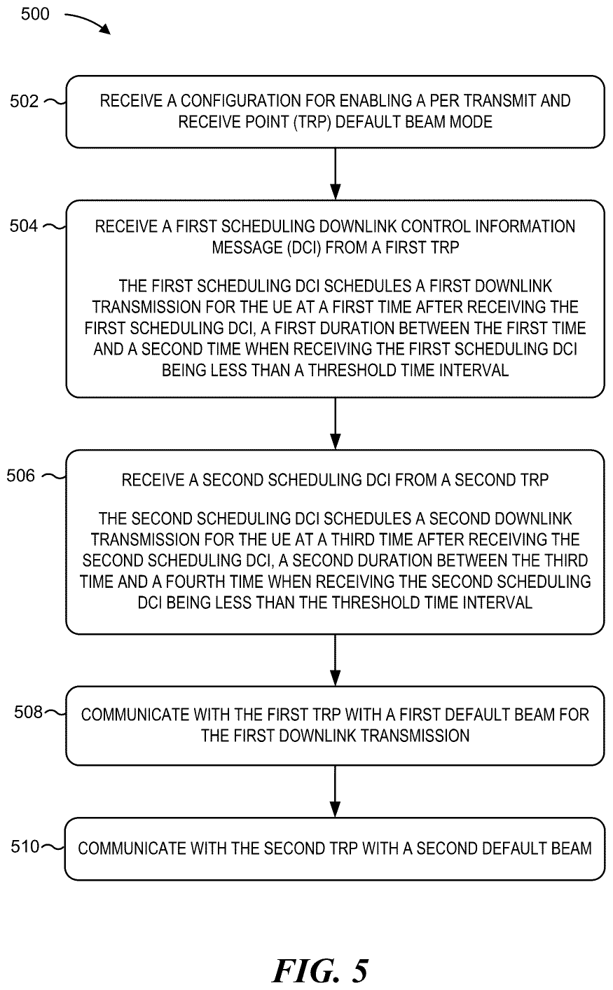

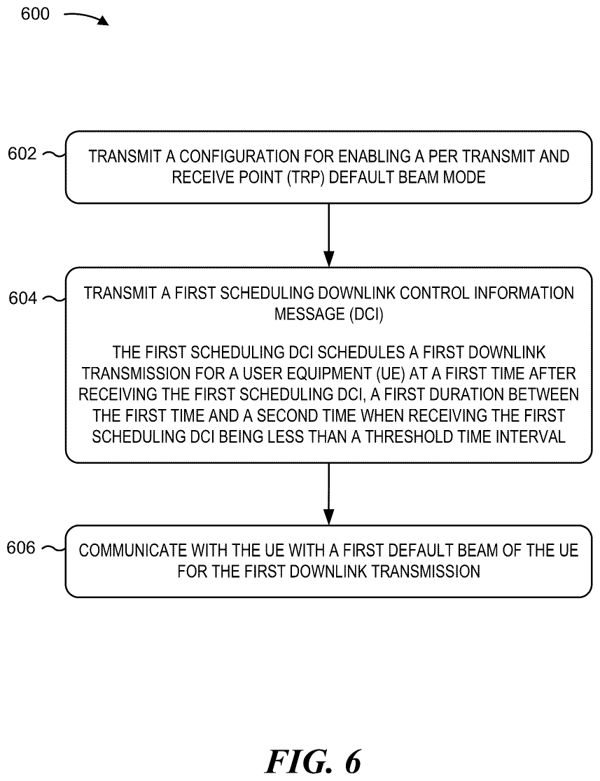

The controller/processor 240 of the base station 110, the controller/processor 280 of the UE 120, and/or any other component(s) of FIG. 2 may perform one or more techniques associated with a default beam rule for a unified TCI in mDCI, mTRP scenarios as described in more detail elsewhere. For example, the controller/processor 240 of the base station 110, the controller/processor 280 of the UE 120, and/or any other component(s) of FIG. 2 may perform or direct operations of, for example, the processes 500 and 600 of FIGS. 5 and 6 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for receiving, means for communicating, means for selecting, means for determining, means for reporting, and means for transmitting. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit—user plane (CU-UP)), control plane functionality (e.g., central unit—control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via O1) or via creation of RAN management policies (such as A1 policies).

A unified transmission configuration indicator (TCI) exists for single transmit and receive point deployments. It would be desirable to extend the unified TCI to multiple transmit and receive point (mTRP) cases. The mTRPs may have particular applicability to customer premises equipment (CPE), fixed wireless access (FWE) devices, vehicles, and industrial devices. A unified TCI framework indicates multiple downlink (DL) and/or uplink (UL) transmission configuration indicator states.

Unified TCI currently applies to single TRP deployments. Unified TCI has three types: downlink only; uplink only; and joint uplink downlink. Downlink only applies to a user equipment (UE) dedicated physical downlink shared channel (PDSCH) and a physical downlink control channel (PDCCH). Uplink only applies to a UE dedicated physical uplink shared channel (PUSCH) and a physical uplink control channel (PUCCH). Joint uplink and downlink may apply to the UE dedicated PDSCH, PDCCH, PUSCH, and PUCCH. The unified TCI is configured in radio resource control (RRC) pools, and activated by a media access control-control element (MAC-CE). DCI format 1_1 or 1_2 can indicate the unified TCI from the activated unified TCIs. The indicated unified TCI will be applied to the applicable channel. Currently, only one unified TCI is indicated by DCI at a time. When the unified TCI state framework is extended to mTRP cases, more than one TCI can be indicated by DCI. For example, one TCI may be indicated per TRP. Table 1 shows an application of channels and reference signals (RSs) in accordance with an activated TCI state.

TABLE 1

| TCI state | | Optional (can be |
|---|---|---|
| type | Mandatory | configured in RRC) |
| Separate | UE dedicated | Non-UE dedicated PDCCH and |
| DL TCI | PDCCH and PDSCH | PDSCH, aperiodic channel state |
| | | information (AP-CSI-RS) for |
| | | CSI, AP-CSI-RS for beam |
| | | management (BM) |
| Separate | UE dedicated PUSCH | SRS for codebook/non-codebook |
| UL TCI | (dynamic grant and | (CB/NCB)/antenna switching |
| | configured grant | (AS), AP SRS for BM |
| | based) and PUCCH | |
| Joint DL | UE dedicated PDCCH and | Non-UE dedicated PDCCH and |
| and UL | PDSCH | PDSCH, AP-CSI-RS for CSI, |
| TCI | UE dedicated PUSCH | AP-CSI-RS for BM |
| | (dynamic grant and | Sounding reference signal |
| | configured grant based) | (SRS) for CB/NCB/AS, AP |
| | and PUCCH | SRS for BM |

A DCI message of format 1_1 or 1_2 can be used to indicate a TCI state with or without scheduling any downlink assignment (e.g., scheduling downlink data). When the DCI is with a downlink assignment, the TCI field will indicate the TCI. When the DCI is without the downlink assignment, a cyclic redundancy check (CRC) of the DCI is scrambled by a configured scheduling radio network temporary identifier (CS-RNTI). To indicate the TCI will be configured, the following fields are set: redundancy version (RV)=all ‘1’s; modulation and coding scheme (MCS)=all ‘1’s; new data indicator (NDI)=0; and frequency domain resource assignment (FDRA) FDRA=all ‘0’s for FDRA Type 0, or all ‘1’s for FDRA Type 1, or all ‘0’s for dynamicSwitch. If all fields match these sequences, the UE knows to look at the TCI field even though downlink data is not being scheduled. Thus, the TCI field, which is always present, indicates the TCI state ID. A PDSCH-to-HARQ_feedback (hybrid automatic repeat request feedback) timing indicator field (if present) indicates the time offset from the DCI to its acknowledgement (ACK) in PUCCH. For type-1 HARQ-ACK codebook, the time domain resource allocation (TDRA) field is used to derive a virtual PDSCH location, which is further used to determine a location for the ACK information in the HARQ-ACK codebook.

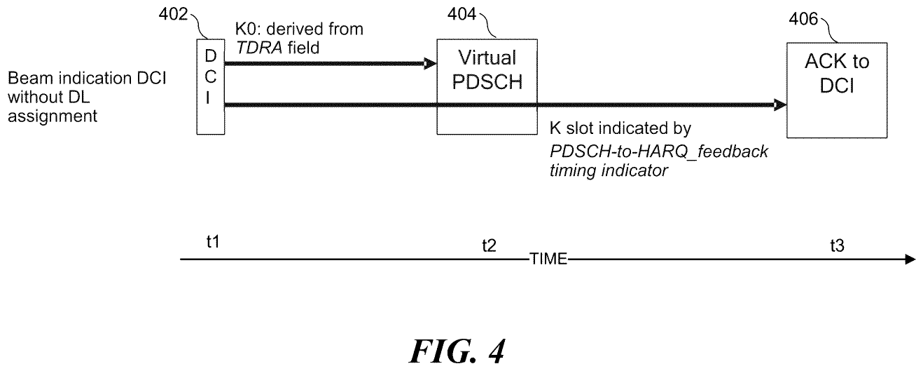

FIG. 4 is a block diagram illustrating a beam indication downlink control information message (DCI) without a downlink assignment, in accordance with various aspects of the present disclosure. A DCI 402 is transmitted at time t1. The DCI 402 does not schedule downlink data. Based on a TDRA field in the DCI 402, a location of a virtual PDSCH 404 is determined. In the example of FIG. 4, the virtual PDSCH 404 is at time t2. The time for acknowledging the DCI is determined based on the virtual PDSCH 404. An ACK 406 is transmitted at time t3. A timing (e.g., time t3) for transmitting the ACK 406 is determined based on the PDSCH-to-HARQ_feedback timing indicator field in the DCI 402.

Multiple TRPs may be deployed to improve spatial diversity of millimeter wave (mmWave) signal reception. Currently, up to two TRPs are considered, but more TRPs are also contemplated for the techniques of the present disclosure.

In the case when multiple DCIs (mDCIs) are used for mTRP deployments, each TRP is associated with a dedicated resource pool, referred to as a control resource set (CORESET) pool. Each TRP transmits its own PDCCH from the associated CORESET to schedule communication from the same TRP. In other words, the DCI from a TRP will schedule the communication from the same TRP. TCI states are associated with each CORESET pool of the TRP.

In the case when a single DCI is used for mTRP deployments, a single DCI can schedule communication from multiple TRPs. When a TCI state is activated via a MAC-CE, the MAC-CE can map a pair of TCIs, each TCI from a TRP, to a TCI codepoint. A DCI will indicate an index of the TCI codepoint for a communication assignment. The pair of beams (each from a TRP) will be used for the communication. In some cases, a CORESET pool may not be configured, and the UE may or may not know the association between the TRP and TCI.

A current default beam rule for a single TRP with unified TCI is as follows: when a time offset between a scheduling DCI and scheduled AP-CSI-RS/PDSCH is smaller than a predefined threshold, a default beam will be used. That is, when the time is too short for the UE to prepare a beam, a default beam is selected. The predefined threshold for determining whether the time is too short is based on a UE capability report.

How a component carrier (CC) is configured dictates how the default beam is selected. A first rule applies when the component carrier is not configured with inter-cell beam management. The first rule defines the default beam as the beam with the indicated TCI that is active in the slot of the scheduled AP-CSI-RS/PDSCH. A second rule applies when the component carrier is configured with inter-cell beam management. The second rule defines the default beam as the beam with the lowest CORESET beam ID in the latest CORESET monitoring occasion before the slot of the scheduled AP-CSI-RS/PDSCH.

Thus, inter-cell beam management controls the selection of the default beam. Inter-cell beam management may be present when a TCI in a serving cell is defined based on a non-serving cell synchronization signal block (SSB), in other words, when the quasi co-location (QCL) relationship for the serving cell is defined based on a non-serving cell synchronization signal block. Thus, a UE can more quickly switch beams. The serving cell configuration contains an information element (IE): additionPCIlist (where PCI is physical cell identifier), which contains the non-serving cell information.

Whether a UE is associated with inter-cell beam management (BM) can be determined based on several factors, such as: whether the additionPCIlist is configured in radio resource control (RRC) signaling; whether the TCI pool configured in RRC signaling in the component carrier or bandwidth part (BWP) contains at least a non-serving cell TCI; whether a non-serving cell TCI has been activated by a MAC-CE; and whether the indicated TCI by the DCI is a non-serving cell TCI.

The first rule described above has issues when a component carrier is not configured with inter-cell beam management because the UE has to memorize two default beams, per CORESET pool, where each TRP may have a different active CORESET pool. Currently, a UE only buffers one default beam configuration. In some examples, two default beams can be defined based on UE capability. If not, only one default beam should be specified. For example, the default beam may be defined based on CORESET pool 0.

It is possible that inter-cell beam management is only configured for one TRP/CORESET pool. In this case, a per TRP granularity is needed when deciding which rule to apply. In some aspects, the second rule described above may be defined in a per TRP version.

According to aspects of the present disclosure, a network device, such as a base station, may configure whether a per TRP default beam mode is enabled. The configuration may be transmitted in RRC signaling. For example, a flag bit may be used in an RRC enableDefaultTCI-StatePerCoresetPoolIndex field.

If the default beam mode is enabled, each TRP/CORESET pool will have its own default beam if the time is too short for the UE to prepare a beam for the scheduled transmission. The default beam may be based on which CORESET pool is associated with the scheduling DCI. In this case, the corresponding default beam will be used. For example, when a component carrier is not associated with inter-cell beam management, then the default beam for a given CORESET pool index is the indicated downlink applicable TCI state for that CORESET pool index in the slot of the scheduled PDSCH/AP-CSI-RS.

Whether inter-cell beam management is to be configured may be determined on a per TRP basis. For example, if the TCI state pool activated TCI list, or indicated TCI of a TRP contains a TCI from a non-serving cell, then the TRP is considered as configured for inter-cell beam management. According to aspects of the present disclosure, the default beam for TRPs with inter-cell beam management will be the TCI of the lowest CORESET ID in the latest CORSET monitoring occasion of the corresponding CORESET pool for the DCI of the TRP that occurs before the scheduled slot of the PDSCH/AP-CSI-RS.

Examples of how to determine whether a TRP is configured for inter-cell beam management are now described. In a first case, only intra-cell beam management is present when no additional physical cell ID (PCI) is configured, that is, no AdditionPCIxxxx information element (IE) is configured. Additionally, when a TCI associated with a non-serving cell PCI is not activated by a MAC-CE or not indicated to be active in a DCI, intra-cell bam management is present. When intra-cell beam management is present, if a useUnifiedTCI flag is configured for any channel/reference signal (RS) at least including any CORESET, one of the rules described above may be used, for example, the first rule. If a useUnifiedTCI flag is not configured for any channel/RS including any CORESET, the other of the rules may be used. For example, the second rule may be used.

Inter-cell beam management may be determined to be present for a TRP when there exists an additional physical cell ID (PCI) configured, that is, an AdditionPCIxxxx IE is configured. When there exists an additional physical cell ID associated with an activated TCI or indicated TCI, inter-cell beam management is also determined to be present. When inter-cell beam management is present, if a useUnifiedTCI flag is configured for any channel/RS including any CORESET, one of the rules described above may be used. For example, the second rule may be used. If a useUnifiedTCI flag is not configured for any channel/RS including any CORESET, the other of the rules may be used. For example, the first rule may be used.

According to aspects of the present disclosure, if the per TRP default beam mode is not enabled, then the same default beam will be applied to the PDSCH and AP-CSI-RS across all TRPs. For example, if both TRPs are not associated with inter-cell beam management, the single default beam for both CORESET pool indexes is the indicated downlink applicable TCI state for a predefined CORESET pool index, such as CORESET pool index 0. As another example, if at least one TRP is associated with inter-cell beam management, the single default beam follows the receive beam for the CORESET with a lowest ID in the latest monitored slot before the scheduled transmission. In this case, the UE looks at all CORESETs from both TRPs. The UE first looks at the most recent monitored slot. If there are CORESETs from both TRPs in this slot, the CORESET with the lowest ID is selected.

According to further aspects of the present disclosure, a UE may transmit a UE capability message for the per TRP default beam mode. For example, the UE may report its capability for supporting per TRP default beam mode. If supported, the network device may configure the per TRP default beam mode for the UE. In some aspects, the per TRP default beam mode is off by default. For example, the mode is off after the UE initially accesses the network, but before receiving an RRC configuration.

According to aspects of the present disclosure, if a UE is configured with a flag (such as “enableDefaultTCI-StatePerCoresetPoolIndex”) to enable a per TRP default beam mode, then the default beam for a given CORESET pool index is the indicated downlink applicable TCI state for that CORESET pool index. If the UE is not configured with the flag and both indicated downlink applicable TCI states are not associated with any additional physical cell ID for a neighbor cell, the single default beam for both CORESET pool indexes is the indicated downlink applicable TCI state for a predefined CORESET pool index. In one implementation, the predefined CORESET pool index is 0. If the UE is not configured with the flag to enable the per TRP default beam mode, and at least one of the indicated downlink applicable TCI states is associated with an additional physical cell ID for a neighbor cell, the single default beam follows the receive beam for the CORESET with a lowest ID in the latest monitored slot.

According to aspects of the present disclosure, a UE does not expect to receive synchronization signal block (SSB) signals for L1-RSRP measurement and PDCCH/PDSCH signals on the same resource element. These aspects may apply for frequency range one (FR1) and/or frequency range two (FR2) communications. These aspects may also apply when the synchronization signal block and PDCCH/PDSCH have the same subcarrier spacing (SCS), for example, when the UE uses the same radio frequency (RF) chain to receive both signals. These aspects may also apply when the synchronization signal block and PDCCH/PDSCH have different subcarrier spacing, regardless of whether the UE can receive data and SSBs simultaneously with different numerologies. For example, the UE may or may not support the configuration “simultaneousRxDataSSB-DiffNumerology.” These aspects may also apply regardless of whether the physical cell IDs of the synchronization signal block and PDCCH/PDSCH are the same.

In other aspects, the UE may receive synchronization signal block signals for L1-RSRP measurement and PDCCH or PDSCH signals on the same resource element, based on its capability. The UE may report such capability on a per basis case. For example, the UE may report a different capability for FR1 and FR2; a different capability for cases when the synchronization signal block and PDCCH/PDSCH have the same or different subcarrier spacing; or a different capability for cases when physical cell IDs of synchronization signal block are the same or different.

In still further aspects of the present disclosure, a downlink control information message (DCI) format associated with an uplink (uplink DCI) may be used to indicate TCI. For example, DCI format 0_1 or 0_2 may be used. In these aspects, a new TCI field(s) may be provided in an uplink scheduling DCI. Alternatively, a sounding reference signal (SRS) resource indicator (SRI) field may be reused. The uplink DCI may or may not also schedule an uplink transmission at the same time. The uplink DCI can be used for at least indicating uplink TCI. Optionally, the uplink DCI may also indicate downlink TCI.

In an mTRP case, a single TCI field can indicate TCI combinations for two TCIs from the two TRPs, or possibly two TCI fields in an uplink DCI. The beam indication may take effect some number of milliseconds after sending the ACK to the DCI. When the uplink DCI also schedules an uplink transmission, the ACK may be the scheduled transmission. When the uplink DCI does not schedule an uplink transmission, the ACK may be a dedicated bit in the HARQ message. More specifically, the PUCCH resource carrying the corresponding HARQ-ACK may be indicated in the uplink DCI, such as in a time domain resource allocation (TDRA) field.

A number of active indicated TCIs for downlink communications is currently limited to one, as a single TRP is assumed. Similarly, for uplink, a number of active indicated TCIs is currently limited to one. According to aspects of the present disclosure, for mTRP cases, the number of active indicated TCIs for downlink and uplink communications is more than one. To implement such a feature, a UE may report its capability for a maximum number of active indicated TCIs. The capability may be a number across TRPs or per TRP, across component carriers/per component carrier, across all channels or resources/per channel or resource, or per downlink or uplink. For a per resource capability, a number of TCIs may be per CSI resource/CORESET for PDCCH. Similarly, a network device may configure a maximum number of active indicated TCIs. The number may be across TRPs/per TRP, across component carriers/per component carrier, or across all channels or resources/per channel or resources.

Examples with respect to a maximum number of active indicated TCIs per TRP will now be described. In a first example, a maximum number of active indicated TCIs per TRP is one for downlink communications. In this example, TCI1 is the indicated TCI for TRP 1. TCI1 is used for PDSCH and PDCCH from TRP 1. After the UE receives a TCI update from TRP 1 to TCI2, then TCI2 replaces TCI1 for reception of PDCCH and PDSCH from TRP 1. This example also applies for uplink transmission of PUSCH and PUCCH.

In a second example, a maximum number of active indicated TCIs per TRP is two for downlink communications. For TRP 0, each TCI is preconfigured with a set of applicable channels and resources. TCI1 is used for PDSCH and PDCCH, TCI2 is used for PDCCH, and TCI3 is used for PDSCH and the CORESET 2 of PDCCH. In this example, TCI1 is currently active. Thus, TCI 1 is used for PDCCH and PDSCH. Later, the UE receives a TCI from DCI indicating TCI2. After TCI2 takes effect, TCI1 is used for PDSCH, and TCI2 is used for PDCCH. Subsequently, the UE receives a TCI indication from DCI indicating TCI3. Because three TCIs have been indicated, which exceeds the maximum number of two, the earliest active TCI indication (e.g., TCI1) will be removed from the active indicated TCI list after TCI3 takes effect. After TCI3 takes effect, TCI2 is used for PDCCH except for the CORESET 2, and TCI3 is used for PDSCH and the CORESET 2 of the PDCCH.

FIG. 5 is a flow diagram illustrating an example process 500 performed, for example, by a user equipment (UE), in accordance with various aspects of the present disclosure. The example process 500 is an example configuring a default beam rule for a unified transmission configuration indication (TCI) in multiple downlink control information message (mDCI), multiple transmit and receive point (mTRP) scenarios. The operations of the process 500 may be implemented by a UE 120.

At block 502, the user equipment (UE) receives a configuration for enabling a per transmit and receive point (TRP) default beam mode. For example, the UE (e.g., using the antenna 252, DEMOD/MOD 254, MIMO detector 256, receive processor 258, controller/processor 280, memory 282, and/or the like) may receive the configuration.

At block 504, the user equipment (UE) receives a first scheduling downlink control information message (DCI) from a first TRP. The first scheduling DCI schedules a first downlink transmission for the UE at a first time after receiving the first scheduling DCI, a first duration between the first time and a second time when receiving the first scheduling DCI being less than a threshold time interval. For example, the UE (e.g., using the antenna 252, DEMOD/MOD 254, MIMO detector 256, receive processor 258, controller/processor 280, memory 282, and/or the like) may receive the first scheduling DCI.

At block 506, the user equipment (UE) receives a second scheduling DCI from a second TRP. The second scheduling DCI schedules a second downlink transmission for the UE at a third time after receiving the second scheduling DCI, a second duration between the third time and a fourth time when receiving the second scheduling DCI being less than the threshold time interval. For example, the UE (e.g., using the antenna 252, DEMOD/MOD 254, MIMO detector 256, receive processor 258, controller/processor 280, memory 282, and/or the like) may receive the second scheduling DCI.

At block 508, the user equipment (UE) communicates with the first TRP with a first default beam for the first downlink transmission. For example, the UE (e.g., using the antenna 252, DEMOD/MOD 254, MIMO detector 256, receive processor 258, TX MIMO processor 266, transmit processor 264, controller/processor 280, memory 282, and/or the like) may communicate with the first TRP. In some aspects, the UE selects the first default beam based on a first control resource set (CORESET) pool associated with the first scheduling DCI for the first TRP in response to the configuration enabling the per TRP default beam mode. The first default beam may be an indicated downlink applicable transmission configuration indication (TCI) state for the first CORESET pool in a slot of a scheduled physical downlink shared channel/aperiodic channel state information reference signal (PDSCH/AP-CSI-RS) when inter-cell beam management is not associated with a component carrier over which the communicating occurs. The first default beam may be a transmission configuration indication (TCI) of a lowest CORESET identifier (ID) in a latest CORESET monitoring occasion of a corresponding CORESET pool before a scheduled slot of the PDSCH/AP-CSI-RS when inter-cell beam management is associated with a component carrier over which the communicating occurs.

Other examples for selecting the first default beam include selecting the first default beam based on an indicated transmission configuration indication (TCI) associated with the first TRP and corresponding control resource set (CORESET) pool, in response to the configuration enabling the per TRP default beam mode, wherein each TRP corresponds to a CORESET pool. In other aspects, the UE selects the first default beam for a control resource set (CORESET) pool corresponding to the first TRP, the selecting based on an indicated downlink applicable transmission configuration indication (TCI) state for a predefined CORESET pool, in response to the first TRP not being associated with any physical cell identifier (PCI) for any neighbor cell and the second TRP not being associated with any PCI for any neighbor cell, and in response to the configuration not enabling the per TRP default beam mode. In still other aspects, the UE selects the first default beam for a control resource set (CORESET) pool corresponding to the first TRP based on a receive beam for a CORESET with a lowest identifier (ID) in a latest monitoring slot before the first downlink transmission, in response to a first downlink applicable transmission configuration indication (TCI) state for the first TRP being associated with a physical cell identifier (PCI) for a neighbor cell, and in response to the configuration not enabling the per TRP default beam mode.

At block 510, the user equipment (UE) communicates with the second TRP with a second default beam. For example, the UE (e.g., using the antenna 252, DEMOD/MOD 254, MIMO detector 256, receive processor 258, TX MIMO processor 266, transmit processor 264, controller/processor 280, memory 282, and/or the like) may communicate with the second TRP. In some aspects, the UE selects the second default beam based on a second CORESET pool associated with the second scheduling DCI for the second TRP in response to the configuration enabling the per TRP default beam mode. In some aspects, the first default beam is the same as the second default beam; and the UE selects the first default beam and the second default beam based on an indicated downlink applicable transmission configuration indication (TCI) state for a predefined control resource set (CORESET) pool index, in response to the configuration not enabling the per TRP default beam mode, the first TRP not being associated with inter-cell beam management, and the second TRP not being associated with inter-cell beam management. In other aspects, the UE selects the first default beam and the second default beam based on a receive beam for a control resource set (CORESET) with a lowest identifier (ID) in a latest monitored slot, in response to the configuration not enabling the per TRP default beam mode, and the first TRP being associated with inter-cell beam management.

FIG. 6 is a flow diagram illustrating an example process 600 performed, for example, by a network device, in accordance with various aspects of the present disclosure. The example process 600 is an example of configuring a default beam rule for a unified transmission configuration indication (TCI) in multiple downlink control information message (mDCI), multiple transmit and receive point (mTRP) scenarios. The operations of the process 600 may be implemented by a base station 110.

At block 602, the base station transmits a configuration for enabling a per transmit and receive point (TRP) default beam mode. For example, the base station (e.g., using the antenna 234, MOD/DEMOD 232, TX MIMO processor 230, transmit processor 220, controller/processor 240, memory 242, and/or the like) may transmit the configuration.

At block 604, the base station transmits a first scheduling downlink control information message (DCI), the first scheduling DCI scheduling a first downlink transmission for a user equipment (UE) at a first time after receiving the first scheduling DCI, a first duration between the first time and a second time when receiving the first scheduling DCI being less than a threshold time interval. For example, the base station (e.g., using the antenna 234, MOD/DEMOD 232, TX MIMO processor 230, transmit processor 220, controller/processor 240, memory 242, and/or the like) may transmit the first scheduling DCI.

At block 606, the base station communicates with the UE with a first default beam of the UE for the first downlink transmission. For example, the base station (e.g., using the antenna 234, MOD/DEMOD 232, MIMO detector 236, receive processor 238, TX MIMO processor 230, transmit processor 220, controller/processor 240, memory 242, and/or the like) may communicate with the UE. In some aspects, the first default beam is selected based on a first control resource set (CORESET) pool associated with the first scheduling DCI for the first TRP in response to the configuration enabling the per TRP default beam mode. The first default beam may be an indicated downlink applicable transmission configuration indication (TCI) state for the first CORESET pool in a slot of a scheduled physical downlink shared channel/aperiodic channel state information reference signal (PDSCH/AP-CSI-RS) when inter-cell beam management is not associated with a component carrier over which the communicating occurs. The first default beam may be a transmission configuration indication (TCI) of a lowest CORESET identifier (ID) in a latest CORESET monitoring occasion of a corresponding CORESET pool before a scheduled slot of the PDSCH/AP-CSI-RS when inter-cell beam management is associated with a component carrier over which the communicating occurs.

Other examples for selecting the first default beam include selecting the first default beam based on an indicated transmission configuration indication (TCI) associated with the first TRP and corresponding control resource set (CORESET) pool, in response to the configuration enabling the per TRP default beam mode, wherein each TRP corresponds to a CORESET pool. In other aspects, the first default beam is selected for a control resource set (CORESET) pool corresponding to the first TRP, the selecting based on an indicated downlink applicable transmission configuration indication (TCI) state for a predefined CORESET pool, in response to the first TRP not being associated with any physical cell identifier (PCI) for any neighbor cell and the second TRP not being associated with any PCI for any neighbor cell, and in response to the configuration not enabling the per TRP default beam mode. In still other aspects, the first default beam is selected for a control resource set (CORESET) pool corresponding to the first TRP based on a receive beam for a CORESET with a lowest identifier (ID) in a latest monitoring slot before the first downlink transmission, in response to a first downlink applicable transmission configuration indication (TCI) state for the first TRP being associated with a physical cell identifier (PCI) for a neighbor cell, and in response to the configuration not enabling the per TRP default beam mode.

### Example Aspects

Aspect 1: A method of wireless communication, by a user equipment (UE), comprising: receiving a configuration for enabling a per transmit and receive point (TRP) default beam mode; receiving a first scheduling downlink control information message (DCI) from a first TRP, the first scheduling DCI scheduling a first downlink transmission for the UE at a first time after receiving the first scheduling DCI, a first duration between the first time and a second time when receiving the first scheduling DCI being less than a threshold time interval; receiving a second scheduling DCI from a second TRP, the second scheduling DCI scheduling a second downlink transmission for the UE at a third time after receiving the second scheduling DCI, a second duration between the third time and a fourth time when receiving the second scheduling DCI being less than the threshold time interval; communicating with the first TRP with a first default beam for the first downlink transmission; and communicating with the second TRP with a second default beam.

Aspect 2: The method of Aspect 1, further comprising: selecting the first default beam based on a first control resource set (CORESET) pool associated with the first scheduling DCI for the first TRP in response to the configuration enabling the per TRP default beam mode; and selecting the second default beam based on a second CORESET pool associated with the second scheduling DCI for the second TRP in response to the configuration enabling the per TRP default beam mode.

Aspect 3: The method of Aspect 1 or 2, in which the first default beam is an indicated downlink applicable transmission configuration indication (TCI) state for the first CORESET pool in a slot of a scheduled physical downlink shared channel/aperiodic channel state information reference signal (PDSCH/AP-CSI-RS) when inter-cell beam management is not associated with a component carrier over which the communicating occurs.

Aspect 4: The method of any of the preceding Aspects, further comprising determining inter-cell beam management is associated with the component carrier of the first TRP based on a TCI for the first TRP indicating a non-serving cell.

Aspect 5: The method of any of Aspects 1 or 2, in which the first default beam comprises a transmission configuration indication (TCI) of a lowest CORESET identifier (ID) in a latest CORESET monitoring occasion of a corresponding CORESET pool before a scheduled slot of the PDSCH/AP-CSI-RS when inter-cell beam management is associated with a component carrier over which the communicating occurs.

Aspect 6: The method of Aspect 1, in which the first default beam is the same as the second default beam; and the method further comprises selecting the first default beam and the second default beam based on an indicated downlink applicable transmission configuration indication (TCI) state for a predefined control resource set (CORESET) pool index, in response to the configuration not enabling the per TRP default beam mode, the first TRP not being associated with inter-cell beam management, and the second TRP not being associated with inter-cell beam management.

Aspect 7: The method of Aspect 1, in which the first default beam is the same as the second default beam; and the method further comprises selecting the first default beam and the second default beam based on a receive beam for a control resource set (CORESET) with a lowest identifier (ID) in a latest monitored slot, in response to the configuration not enabling the per TRP default beam mode, and the first TRP being associated with inter-cell beam management.

Aspect 8: The method of any of the preceding Aspects, further comprising reporting a UE capability indicating whether the UE supports the per TRP default beam mode.

Aspect 9: The method of any of the preceding Aspects, further comprising selecting the first default beam based on an indicated transmission configuration indication (TCI) associated with the first TRP and corresponding control resource set (CORESET) pool, in response to the configuration enabling the per TRP default beam mode, wherein each TRP corresponds to a CORESET pool.

Aspect 10: The method of any of the preceding Aspects 1-8, further comprising selecting the first default beam for a control resource set (CORESET) pool corresponding to the first TRP, the selecting based on an indicated downlink applicable transmission configuration indication (TCI) state for a predefined CORESET pool, in response to the first TRP not being associated with any physical cell identifier (PCI) for any neighbor cell and the second TRP not being associated with any PCI for any neighbor cell, and in response to the configuration not enabling the per TRP default beam mode.

Aspect 11: The method of any of the Aspects 1-8, further comprising selecting the first default beam for a control resource set (CORESET) pool corresponding to the first TRP based on a receive beam for a CORESET with a lowest identifier (ID) in a latest monitoring slot before the first downlink transmission, in response to a first downlink applicable transmission configuration indication (TCI) state for the first TRP being associated with a physical cell identifier (PCI) for a neighbor cell, and in response to the configuration not enabling the per TRP default beam mode.

Aspect 12: A method of wireless communication, by a network device comprising: transmitting a configuration for enabling a per transmit and receive point (TRP) default beam mode; transmitting a first scheduling downlink control information message (DCI), the first scheduling DCI scheduling a first downlink transmission for a user equipment (UE) at a first time after receiving the first scheduling DCI, a first duration between the first time and a second time when receiving the first scheduling DCI being less than a threshold time interval; and communicating with the UE with a first default beam of the UE for the first downlink transmission.

Aspect 13: The method of Aspect 12, in which the first default beam is selected based on a first control resource set (CORESET) pool associated with the first scheduling DCI for a TRP in response to the configuration enabling the per TRP default beam mode.

Aspect 14: The method of Aspects 12 or 13, in which the first default beam is an indicated downlink applicable transmission configuration indication (TCI) state for the first CORESET pool in a slot of a scheduled physical downlink shared channel/aperiodic channel state information reference signal (PDSCH/AP-CSI-RS) when inter-cell beam management is not associated with a component carrier over which the communicating occurs.

Aspect 15: The method of any of the Aspects 12-14, further comprising determining inter-cell beam management is associated with the component carrier of the TRP based on a TCI for the TRP indicating a non-serving cell.

Aspect 16: The method of any of the Aspects 12 or 13, in which the first default beam comprises a transmission configuration indication (TCI) of a lowest CORESET identifier (ID) in a latest CORESET monitoring occasion of a corresponding CORESET pool before a scheduled slot of the PDSCH/AP-CSI-RS when inter-cell beam management is associated with a component carrier over which the communicating occurs.

Aspect 17: The method of Aspect 12, in which the first default beam is the same as a second default beam associated with another network device; and the first default beam is selected based on an indicated downlink applicable transmission configuration indication (TCI) state for a predefined control resource set (CORESET) pool index, in response to the configuration not enabling the per TRP default beam mode, and a TRP not being associated with inter-cell beam management.

Aspect 18: The method of Aspect 12, in which the first default beam is the same as a second default beam associated with another network device; and the first default beam is selected based on a receive beam for a control resource set (CORESET) with a lowest identifier (ID) in a latest monitored slot, in response to the configuration not enabling the per TRP default beam mode, and a TRP being associated with inter-cell beam management.

Aspect 19: The method of any of the Aspects 12-18, further comprising receiving a UE capability indicating whether the UE supports the per TRP default beam mode.

Aspect 20: The method of any of the Aspects 12-19, in which the first default beam is selected based on an indicated transmission configuration indication (TCI) associated with a TRP and corresponding control resource set (CORESET) pool, in response to the configuration enabling the per TRP default beam mode, wherein each TRP corresponds to a CORESET pool.

Aspect 21: The method of any of the Aspects 12-20, in which the first default beam is selected for a control resource set (CORESET) pool corresponding to a TRP, the selecting based on an indicated downlink applicable transmission configuration indication (TCI) state for a predefined CORESET pool, in response to the TRP not being associated with any physical cell identifier (PCI) for any neighbor cell, and in response to the configuration not enabling the per TRP default beam mode.

Aspect 22: The method of any of the Aspects 12-20, in which the first default beam is selected for a control resource set (CORESET) pool corresponding to a TRP based on a receive beam for a CORESET with a lowest identifier (ID) in a latest monitoring slot before the first downlink transmission, in response to a first downlink applicable transmission configuration indication (TCI) state for the TRP being associated with a physical cell identifier (PCI) for a neighbor cell, and in response to the configuration not enabling the per TRP default beam mode.

Aspect 23: An apparatus for wireless communication, by a user equipment (UE), comprising: a memory; and at least one processor coupled to the memory, the at least one processor configured: to receive a configuration for enabling a per transmit and receive point (TRP) default beam mode; to receive a first scheduling downlink control information message (DCI) from a first TRP, the first scheduling DCI scheduling a first downlink transmission for the UE at a first time after receiving the first scheduling DCI, a first duration between the first time and a second time when receiving the first scheduling DCI being less than a threshold time interval; to receive a second scheduling DCI from a second TRP, the second scheduling DCI scheduling a second downlink transmission for the UE at a third time after receiving the second scheduling DCI, a second duration between the third time and a fourth time when receiving the second scheduling DCI being less than the threshold time interval; to communicate with the first TRP with a first default beam for the first downlink transmission; and to communicate with the second TRP with a second default beam.

Aspect 24: The apparatus of Aspect 23, in which the at least one processor is further configured: to select the first default beam based on a first control resource set (CORESET) pool associated with the first scheduling DCI for the first TRP in response to the configuration enabling the per TRP default beam mode; and to select the second default beam based on a second CORESET pool associated with the second scheduling DCI for the second TRP in response to the configuration enabling the per TRP default beam mode.

Aspect 25: The apparatus of Aspect 23 or 24, in which the first default beam is an indicated downlink applicable transmission configuration indication (TCI) state for the first CORESET pool in a slot of a scheduled physical downlink shared channel/aperiodic channel state information reference signal (PDSCH/AP-CSI-RS) when inter-cell beam management is not associated with a component carrier over which the communicating occurs.

Aspect 26: The apparatus of any of the Aspects 23-25, in which the at least one processor is further configured to determine inter-cell beam management is associated with the component carrier of the first TRP based on a TCI for the first TRP indicating a non-serving cell.

Aspect 27: The apparatus of any of the Aspects 23-27, in which the first default beam comprises a transmission configuration indication (TCI) of a lowest CORESET identifier (ID) in a latest CORESET monitoring occasion of a corresponding CORESET pool before a scheduled slot of the PDSCH/AP-CSI-RS when inter-cell beam management is associated with a component carrier over which the communicating occurs.

Aspect 28: The apparatus of any of the Aspects 23-27, in which the first default beam is the same as the second default beam; and the at least one processor is further configured to select the first default beam and the second default beam based on an indicated downlink applicable transmission configuration indication (TCI) state for a predefined control resource set (CORESET) pool index, in response to the configuration not enabling the per TRP default beam mode, the first TRP not being associated with inter-cell beam management, and the second TRP not being associated with inter-cell beam management.

Aspect 29: The apparatus of any of the Aspects 23-27, in which the first default beam is the same as the second default beam; and the at least one processor is further configured to select the first default beam and the second default beam based on a receive beam for a control resource set (CORESET) with a lowest identifier (ID) in a latest monitored slot, in response to the configuration not enabling the per TRP default beam mode, and the first TRP being associated with inter-cell beam management.

Aspect 30: The apparatus of any of the Aspects 23-29, in which the at least one processor is further configured to report a UE capability indicating whether the UE supports the per TRP default beam mode.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication, by a user equipment (UE), comprising:
receiving a configuration for enabling a per transmit and receive point (TRP) default beam mode;
receiving a first scheduling downlink control information message (DCI) from a first TRP, the first scheduling DCI scheduling a first downlink transmission for the UE at a first time after receiving the first scheduling DCI, a first duration between the first time and a second time when receiving the first scheduling DCI being less than a threshold time interval;
receiving a second scheduling DCI from a second TRP, the second scheduling DCI scheduling a second downlink transmission for the UE at a third time after receiving the second scheduling DCI, a second duration between the third time and a fourth time when receiving the second scheduling DCI being less than the threshold time interval;
communicating with the first TRP with a first default beam for the first downlink transmission; and
communicating with the second TRP with a second default beam.

2. The method of claim 1, further comprising:
selecting the first default beam based on a first control resource set (CORESET) pool associated with the first scheduling DCI for the first TRP in response to the configuration enabling the per TRP default beam mode; and
selecting the second default beam based on a second CORESET pool associated with the second scheduling DCI for the second TRP in response to the configuration enabling the per TRP default beam mode.

3. The method of claim 2, in which the first default beam is an indicated downlink applicable transmission configuration indication (TCI) state for the first CORESET pool in a slot of a scheduled physical downlink shared channel/aperiodic channel state information reference signal (PDSCH/AP-CSI-RS) when inter-cell beam management is not associated with a component carrier over which the communicating occurs.

4. The method of claim 3, further comprising determining inter-cell beam management is associated with the component carrier of the first TRP based on a TCI for the first TRP indicating a non-serving cell.

5. The method of claim 2, in which the first default beam comprises a transmission configuration indication (TCI) of a lowest CORESET identifier (ID) in a latest CORESET monitoring occasion of a corresponding CORESET pool before a scheduled slot of the PDSCH/AP-CSI-RS when inter-cell beam management is associated with a component carrier over which the communicating occurs.

6. The method of claim 1, in which the first default beam is the same as the second default beam; and
the method further comprises selecting the first default beam and the second default beam based on an indicated downlink applicable transmission configuration indication (TCI) state for a predefined control resource set (CORESET) pool index, in response to the configuration not enabling the per TRP default beam mode, the first TRP not being associated with inter-cell beam management, and the second TRP not being associated with inter-cell beam management.

7. The method of claim 1, in which the first default beam is the same as the second default beam; and
the method further comprises selecting the first default beam and the second default beam based on a receive beam for a control resource set (CORESET) with a lowest identifier (ID) in a latest monitored slot, in response to the configuration not enabling the per TRP default beam mode, and the first TRP being associated with inter-cell beam management.

8. The method of claim 1, further comprising reporting a UE capability indicating whether the UE supports the per TRP default beam mode.

9. The method of claim 1, further comprising selecting the first default beam based on an indicated transmission configuration indication (TCI) associated with the first TRP and corresponding control resource set (CORESET) pool, in response to the configuration enabling the per TRP default beam mode, wherein each TRP corresponds to a CORESET pool.

10. The method of claim 1, further comprising selecting the first default beam for a control resource set (CORESET) pool corresponding to the first TRP, the selecting based on an indicated downlink applicable transmission configuration indication (TCI) state for a predefined CORESET pool, in response to the first TRP not being associated with any physical cell identifier (PCI) for any neighbor cell and the second TRP not being associated with any PCI for any neighbor cell, and in response to the configuration not enabling the per TRP default beam mode.

11. The method of claim 1, further comprising selecting the first default beam for a control resource set (CORESET) pool corresponding to the first TRP based on a receive beam for a CORESET with a lowest identifier (ID) in a latest monitoring slot before the first downlink transmission, in response to a first downlink applicable transmission configuration indication (TCI) state for the first TRP being associated with a physical cell identifier (PCI) for a neighbor cell, and in response to the configuration not enabling the per TRP default beam mode.

12. A method of wireless communication, by a network device comprising:
transmitting a configuration for enabling a per transmit and receive point (TRP) default beam mode;
transmitting a first scheduling downlink control information message (DCI), the first scheduling DCI scheduling a first downlink transmission for a user equipment (UE) at a first time after receiving the first scheduling DCI, a first duration between the first time and a second time when receiving the first scheduling DCI being less than a threshold time interval; and
communicating with the UE with a first default beam of the UE for the first downlink transmission.

13. The method of claim 12, in which the first default beam is selected based on a first control resource set (CORESET) pool associated with the first scheduling DCI for a TRP in response to the configuration enabling the per TRP default beam mode.

14. The method of claim 13, in which the first default beam is an indicated downlink applicable transmission configuration indication (TCI) state for the first CORESET pool in a slot of a scheduled physical downlink shared channel/aperiodic channel state information reference signal (PDSCH/AP-CSI-RS) when inter-cell beam management is not associated with a component carrier over which the communicating occurs.

15. The method of claim 14, further comprising determining inter-cell beam management is associated with the component carrier of the TRP based on a TCJ for the TRP indicating a non-serving cell.

16. The method of claim 13, in which the first default beam comprises a transmission configuration indication (TCI) of a lowest CORESET identifier (ID) in a latest CORESET monitoring occasion of a corresponding CORESET pool before a scheduled slot of the PDSCH/AP-CSI-RS when inter-cell beam management is associated with a component carrier over which the communicating occurs.

17. The method of claim 12, in which the first default beam is the same as a second default beam associated with another network device; and
the first default beam is selected based on an indicated downlink applicable transmission configuration indication (TCI) state for a predefined control resource set (CORESET) pool index, in response to the configuration not enabling the per TRP default beam mode, and a TRP not being associated with inter-cell beam management.

18. The method of claim 12, in which the first default beam is the same as a second default beam associated with another network device; and
the first default beam is selected based on a receive beam for a control resource set (CORESET) with a lowest identifier (ID) in a latest monitored slot, in response to the configuration not enabling the per TRP default beam mode, and a TRP being associated with inter-cell beam management.

19. The method of claim 12, further comprising receiving a UE capability indicating whether the UE supports the per TRP default beam mode.

20. The method of claim 12, in which the first default beam is selected based on an indicated transmission configuration indication (TCI) associated with a TRP and corresponding control resource set (CORESET) pool, in response to the configuration enabling the per TRP default beam mode, wherein each TRP corresponds to a CORESET pool.

21. The method of claim 12, in which the first default beam is selected for a control resource set (CORESET) pool corresponding to a TRP, the selecting based on an indicated downlink applicable transmission configuration indication (TCI) state for a predefined CORESET pool, in response to the TRP not being associated with any physical cell identifier (PCI) for any neighbor cell, and in response to the configuration not enabling the per TRP default beam mode.

22. The method of claim 12, in which the first default beam is selected for a control resource set (CORESET) pool corresponding to a TRP based on a receive beam for a CORESET with a lowest identifier (ID) in a latest monitoring slot before the first downlink transmission, in response to a first downlink applicable transmission configuration indication (TCI) state for the TRP being associated with a physical cell identifier (PCI) for a neighbor cell, and in response to the configuration not enabling the per TRP default beam mode.

23. An apparatus for wireless communication, by a user equipment (UE), comprising:
a memory; and
at least one processor coupled to the memory, the at least one processor configured:
to receive a configuration for enabling a per transmit and receive point (TRP) default beam mode;
to receive a first scheduling downlink control information message (DCI) from a first TRP, the first scheduling DCI scheduling a first downlink transmission for the UE at a first time after receiving the first scheduling DCI, a first duration between the first time and a second time when receiving the first scheduling DCI being less than a threshold time interval;
to receive a second scheduling DCI from a second TRP, the second scheduling DCI scheduling a second downlink transmission for the UE at a third time after receiving the second scheduling DCI, a second duration between the third time and a fourth time when receiving the second scheduling DCI being less than the threshold time interval;
to communicate with the first TRP with a first default beam for the first downlink transmission; and
to communicate with the second TRP with a second default beam.

24. The apparatus of claim 23, in which the at least one processor is further configured:
to select the first default beam based on a first control resource set (CORESET) pool associated with the first scheduling DCI for the first TRP in response to the configuration enabling the per TRP default beam mode; and
to select the second default beam based on a second CORESET pool associated with the second scheduling DCI for the second TRP in response to the configuration enabling the per TRP default beam mode.

25. The apparatus of claim 24, in which the first default beam is an indicated downlink applicable transmission configuration indication (TCI) state for the first CORESET pool in a slot of a scheduled physical downlink shared channel/aperiodic channel state information reference signal (PDSCH/AP-CSI-RS) when inter-cell beam management is not associated with a component carrier over which the communicating occurs.

26. The apparatus of claim 25, in which the at least one processor is further configured to determine inter-cell beam management is associated with the component carrier of the first TRP based on a TCI for the first TRP indicating a non-serving cell.

27. The apparatus of claim 24, in which the first default beam comprises a transmission configuration indication (TCI) of a lowest CORESET identifier (ID) in a latest CORESET monitoring occasion of a corresponding CORESET pool before a scheduled slot of the PDSCH/AP-CSI-RS when inter-cell beam management is associated with a component carrier over which the communicating occurs.

28. The apparatus of claim 23, in which the first default beam is the same as the second default beam; and
the at least one processor is further configured to select the first default beam and the second default beam based on an indicated downlink applicable transmission configuration indication (TCI) state for a predefined control resource set (CORESET) pool index, in response to the configuration not enabling the per TRP default beam mode, the first TRP not being associated with inter-cell beam management, and the second TRP not being associated with inter-cell beam management.

29. The apparatus of claim 23, in which the first default beam is the same as the second default beam; and
the at least one processor is further configured to select the first default beam and the second default beam based on a receive beam for a control resource set (CORESET) with a lowest identifier (ID) in a latest monitored slot, in response to the configuration not enabling the per TRP default beam mode, and the first TRP being associated with inter-cell beam management.

30. The apparatus of claim 23, in which the at least one processor is further configured to report a UE capability indicating whether the UE supports the per TRP default beam mode.
